(19) United States
(12) Patent Application Publication
(10) Pub. No.: US 2007/0083316 A1
(43) Pub. Date: Apr. 12, 2007

(54) Method for modifying a motor vehicle's acceleration mode

(76) Inventors: Gerhard Kurz, Wendlingen (DE); Harry Troester, Tamm (DE); Richard Zimmer, Fellbach (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/566,947

(22) PCT Filed: Jul. 29, 2004
(86) PCT No.: PCT/EP04/08488

§ 371 Date: Aug. 10, 2006

(30) Foreign Application Priority Data
Aug. 5, 2003 (DE) 10335732.7

(51) Int. Cl. G05D 1/00

(52) U.S. Cl. 701/93; 701/1

(57) ABSTRACT

In a method for changing the acceleration mode of a motor vehicle, the driver can change from a normal acceleration mode into a rapid acceleration mode to increase the supply of air and fuel. The change into the rapid acceleration mode is carried out if the driver exceeds a pedal-speed threshold value when activating the accelerator pedal.

### BACKGROUND AND SUMMARY OF THE INVENTION

This application claims the priority of German patent document no. 103 35 732.7, filed Aug. 5, 2003 (PCT International Application No. PCT/EP2004/008488, filed Jul. 29, 2004), the disclosure of which is expressly incorporated by reference herein.

The present invention relates to a method for changing the acceleration mode of a motor vehicle wherein the acceleration mode can be changed by the driver between a normal acceleration mode and a rapid acceleration mode in which the supply of air and fuel is increased.

U.S. Patent No. 5,884,208 describes a method in which the driver can change manually between a normal acceleration mode and a rapid acceleration mode using a switch. A greater supply of air and fuel to the internal combustion engine is assigned to the accelerator pedal positions generated by the driver in the rapid acceleration mode than in the normal acceleration mode. Depressing the accelerator pedal causes greater acceleration in the rapid acceleration mode than in the normal acceleration mode.

However, it is considered disadvantageous in the known method that in order to change the acceleration mode the driver has to activate the additional switch. In order to return from the rapid acceleration mode into the normal acceleration mode the switch must be activated again. The activation of the switch has an adverse effect on comfort and can lead to situations which are critical for safety, in particular if the vehicle is in the rapid acceleration mode since the driver is distracted if no additional and automatically executed measures for automatically resetting the acceleration mode are provided.

The present invention is based on recognition of the problem of providing various acceleration modes in a motor vehicle which can be selected by the driver with a high degree of comfort accompanied by a high level of safety.

This problem has been solved according to the invention by providing that the change from the normal acceleration mode into the rapid acceleration mode is carried out if the driver exceeds a pedal-speed threshold value when activating the accelerator pedal. The acceleration mode is increased exclusively via the way in which the accelerator pedal is activated; on the other hand there is no need to activate an additional switch. This new procedure is comfortable because the acceleration mode is controlled additionally by the accelerator pedal which has to be activated in any case. Furthermore, the driving safety is also increased inasmuch as the driver is not distracted by additional activation processes and the change of the acceleration mode by the activation of the accelerator pedal is carried out intuitively by the driver.

In the rapid acceleration mode, more fuel and air is introduced into the combustion chambers of the internal combustion engine while the activation of the accelerator pedal is the same compared to the normal acceleration mode, and as a result a higher engine power and/or a higher engine torque are generated with the same activation of the accelerator pedal. The change in the acceleration mode is expediently accompanied by an adaptation of engine characteristic curves which can be raised from the normal acceleration mode into the rapid acceleration mode according to predefined functions of time. If, for example, a maximum engine drive torque is aimed at in the rapid acceleration mode, the engine drive torque can be increased according to the predefined function of time, for example as a ramp, when shifting up into the rapid acceleration mode. The same applies if other variables, for example the power of the engine, are to be maximized or optimized.

Conversely, the corresponding engine characteristics can be restored according to defined functions of time when returning the acceleration mode from the rapid acceleration mode into the normal acceleration mode. These functions of time may be the same as those when shifting up from the normal acceleration mode into the rapid acceleration mode, or may be embodied in a different way.

It can basically be sufficient to take into account the pedal speed as a criterion for the change into the rapid acceleration mode. On the other hand, the shifting up from the normal acceleration mode into the rapid acceleration mode can be additionally tied to the fulfilment of one or more further criteria in addition to the condition that a pedal-speed threshold value is exceeded when the accelerator pedal is activated. For example, it may be indicated to shift into the rapid acceleration mode only if, as an additional criterion, the accelerator pedal position exceeds a switch-on threshold value. This ensures that a sudden activation of the accelerator pedal with a high gradient, starting from the neutral home position of the accelerator pedal, does not immediately bring about a change into the rapid acceleration mode but rather said change is not brought about until when the accelerator pedal is activated again.

The criteria which have to be fulfilled for the change into the rapid acceleration mode may either be permanently predefined or be variables which are tied, for example, to specific types of driver. If a driver-type classification unit is provided in the vehicle, the driver can be subjected automatically to a classification of the type of driver by the driving style or driver reaction, and the driver can thus be assigned to a type of driver class. Depending on the type of driver class, the threshold values or limiting values which are relevant for a change in the acceleration mode can assume various values. Sporty driving styles which lead to a corresponding driver-type classification may, for example, give rise to steeper gradients and higher values in the rapid acceleration mode than cautious driving styles.

Ambient states can also be sensed as a safety-related criterion using a senor system which senses the surroundings, with states being definable that are critical for safety, and the reaching or exceeding of which states prevents a change from the normal acceleration mode into the rapid acceleration mode. It is thus particularly advantageous to prevent the rapid acceleration mode if the distance from a vehicle travelling in front or some other extraneous object becomes less than a value which is critical for safety.

It may be sufficient, as a criterion for changing back from the rapid acceleration mode into the normal acceleration mode, that the driver returns the accelerator pedal position in the direction of the home position, in which case merely reversing the pedal speed may be sufficient and the home position does not necessarily need to be reached again. The returning of the gas pedal position may be sensed, for example, by a negative pedal speed.

It is also basically contemplated to provide a plurality of different acceleration modes in which the vehicle is shifted when different criteria are reached. It thus may be particularly expedient also to assign different rapid acceleration modes to different pedal speeds.

Other objects, advantages and novel features of the present invention will become apparent from the following detailed description of the invention when considered in conjunction with the accompanying drawings.

### BRIEF DESCRIPTION OF THE DRAWINGS

FIG. 1 is a diagram showing an exemplary profile of the pedal travel of the accelerator pedal, and an associated diagram showing the profile of the engine drive torque, and

FIG. 2 is a flowchart illustrating the method for changing over from the normal acceleration mode into the rapid acceleration mode and for returning to the normal acceleration mode.

### DETAILED DESCRIPTION OF THE DRAWINGS

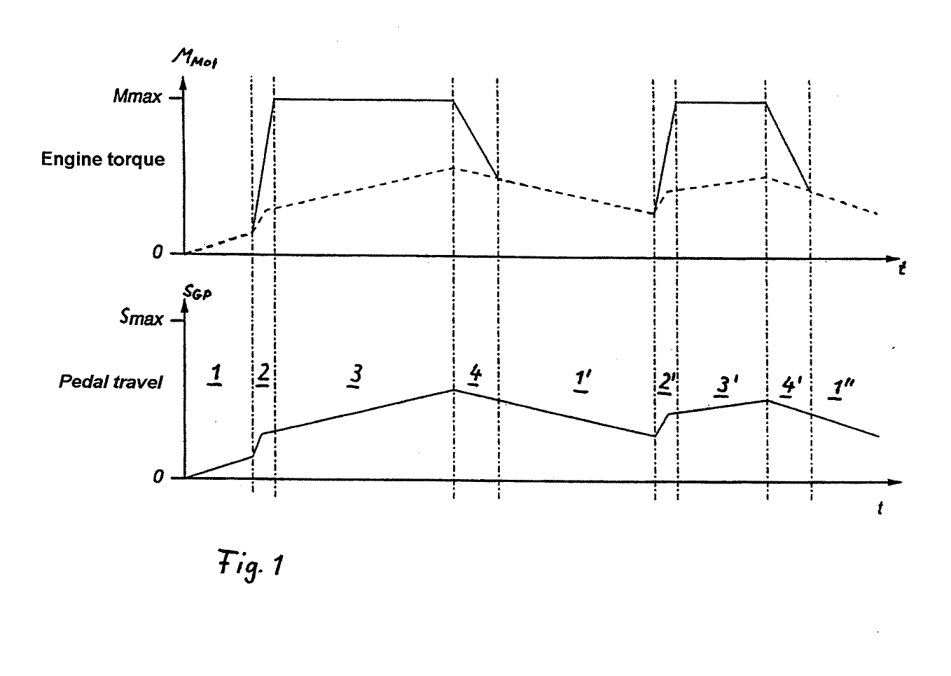

The lower diagram in FIG. 1 shows an exemplary profile of the pedal travel s_{GP} of the accelerator pedal as a function of time. In the upper part of the diagram, the associated profile of the driving engine torque M_{Mot} is entered, with the engine torque which corresponds to a rapid acceleration mode being shown by an unbroken line and the engine torque which corresponds to a normal acceleration mode being shown by a dashed line. The engine torque M_{Mot} for the normal acceleration mode has a directly proportional profile to the pedal travel s_{GP} of the accelerator pedal; each change in the accelerator pedal brings about a corresponding change in the engine torque. In contrast, the profile of the engine torque M_{Mot} for the rapid acceleration mode differs in part considerably from the assigned accelerator pedal travel s_{GP}. In the rapid acceleration mode, depressing the accelerator pedal results in a disproportionally high increase in the engine torque M_{Mot}. This will be indicated below by various sections in the profile of the accelerator pedal travel s_{GP}.

In a first acceleration section 1, the accelerator pedal is deflected starting from the neutral home position where s_{GP}=0, the pedal speed still being below a pedal-speed threshold value, the exceeding of which causes a change from the normal acceleration mode into the rapid acceleration mode. In the acceleration section 1, the motor vehicle is thus in the normal acceleration mode in which an engine torque M_{Mot} (dashed line in the upper part of the diagram) which is proportional to the pedal travel s_{GP} is generated.

In the second acceleration section 2, the accelerator pedal is deflected to a greater degree in such a way that the pedal speed v_{GP} exceeds a predefined pedal-speed threshold value v_{GP,Grenz}. There is then a change from the normal acceleration mode into the rapid acceleration mode in which, according to the unbroken line in the upper part of the diagram, the engine torque M_{Mot} is increased automatically to a maximum value Mₘₐₓ. This maximum engine drive torque is also retained in the following acceleration section 3 in which the accelerator pedal is deflected or activated further, but with a lower pedal speed than in the preceding acceleration section 2.

In the next acceleration section 4, the driver returns the accelerator pedal, as a result of which the pedal speed reverses. This is taken as a criterion to change back from the rapid acceleration mode into the normal acceleration mode. Correspondingly, the engine torque M_{Mot} is returned from the maximum value Mₘₐₓ to the value which corresponds to the normal acceleration mode which is illustrated by the dashed line and in which the generated engine torque M_{Mot} is proportional to the accelerator pedal travel s_{GP}.

When there is a change from the normal acceleration mode into the rapid acceleration mode (section 2) the engine torque M_{Mot} is increased to the maximum value Mₘₐₓ in accordance with a ramp function. A ramp function is also applied in order to return the engine torque from the maximum value Mₘₐₓ to the value corresponding to the normal acceleration mode when changing back from the rapid acceleration mode into the normal acceleration mode (section 4).

In the next acceleration section 1′, the motor vehicle is firstly still in the normal acceleration mode. When the accelerator pedal is deflected to a high degree again in the subsequent acceleration section 2′ with a pedal speed above the pedal-speed threshold value, there is again a change from the normal acceleration mode into the rapid acceleration mode, and the engine torque M_{Mot} correspondingly rises with a ramp function to the maximum value Mₘₐₓ which is also retained in the following acceleration section 3′ in which the accelerator pedal is deflected to an even greater degree. In the acceleration section 4′, the accelerator pedal position is returned in the direction of the home position, after which there is change from the rapid acceleration mode into the normal acceleration mode and the engine torque is returned from the maximum value Mₘₐₓ in a ramp shape to the value which is proportional to the deflection of the accelerator pedal. In the last acceleration section 1″ illustrated, the vehicle is again in the normal acceleration mode.

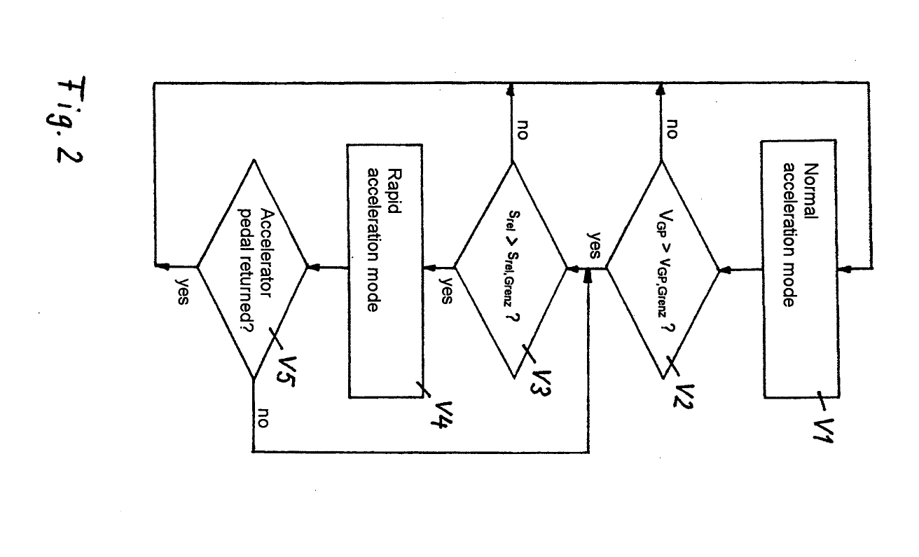

The method sequence for the change from the normal acceleration mode into the rapid acceleration mode and back again into the normal acceleration mode is illustrated in FIG. 2. At the starting point step V1 of the method the motor vehicle is in the normal acceleration mode. In the following method step V2 there is an interrogation to determine whether the condition for the change into the rapid acceleration mode is met. This is the case if the pedal speed v_{GP} of the accelerator pedal is greater than a given pedal-speed threshold value v_{GP,Grenz}. If this condition is not met, the system returns to the first method step V1 in accordance with the No branching operation, and the normal acceleration mode is retained until the condition is met. Otherwise, the system continues to the next method step V3 in accordance with the Yes branching operation.

In the method step V3, an additional condition is checked, it being necessary for that addresses condition to be fulfilled for there to be a change into the rapid acceleration mode. This condition is the interrogation as to whether the relative distance sᵣₑₗ between the vehicle and a vehicle travelling in front is greater than a safety distance s_{rel,Grenz}. In order to measure the relative distance sᵣₑₗ, a suitable sensor system, for example a radar device, is carried in the vehicle. The safety distance s_{rel,Grenz} depends in particular on the speed of the vehicle, but it is also contemplated for influence variables which are specific of a type of driver to be used to obtain the safety distance and these are to be determined by a driver type classification process.

If, as is checked in method step V3, the relative distance sᵣₑₗ becomes or is less than the safety distance s_{rel,Grenz}, the system returns to the method step V1 in accordance with the No branching operation, and the normal acceleration mode is retained. Otherwise, all the conditions for the change into the rapid acceleration mode are fulfilled so that the system continues to the method step V4 in accordance with the Yes branching operation, and the change into the rapid acceleration mode can be carried out.

In the rapid acceleration mode, modified engine characteristic curves by means of which the air supply and the injection of fuel into the internal combustion engine are controlled are activated. In particular, the engine torque is raised to the maximum value even if the position of the accelerator pedal has not yet reached the maximum deflection.

In the method step V5 it is checked whether conditions which lead to a return from the rapid acceleration mode into the normal acceleration mode are met. This is the case if the driver returns the accelerator pedal position in the direction of the home position; the system is then returned to the first method step V1 in accordance with the Yes branching operation, and the normal acceleration mode is set again. If, on the other hand, the driver has not returned the accelerator pedal position, the rapid acceleration mode is retained and the system is returned to the method step V3 in accordance with the No branching operation, in which method step V3 it is checked at cyclical intervals whether criteria which are relevant for safety are infringed, said criteria also resulting in a change into the normal acceleration mode.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for changing the acceleration mode of a motor vehicle, wherein the acceleration mode can be changed by the driver between a normal acceleration mode and a rapid acceleration mode in which the supply of air and fuel is increased, comprising changing from the normal acceleration mode into the rapid acceleration mode if a pedal-speed threshold value is exceeded when an accelerator pedal is activated.

12. The method as claimed in claim 11, wherein the changing from the normal acceleration mode into the rapid acceleration mode is independent of a current pedal position of the accelerator pedal between a neutral home position and a maximum activation position.

13. The method as claimed in claim 11, wherein the changing from the normal acceleration mode into the rapid acceleration mode is carried out only when a pedal position of the accelerator pedal exceeds a switch-on threshold value.

14. The method as claimed in claim 11, wherein acceleration in the rapid acceleration mode takes place with maximum engine drive torque.

15. The method as claimed in claim 11, further comprising classifying driver type such that a criteria for the changing between the normal acceleration mode and the rapid acceleration mode are determined as a function of the drive type.

16. The method as claimed in claim 15, wherein the classifying is carried out automatically by measurable driver reactions.

17. The method as claimed in claim 11, further comprising sensing ambient states using a surroundings sensor system, and when values that are critical for safety are reached, a changing from the normal acceleration mode into the rapid acceleration mode is prevented.

18. The method as claimed in claim 17, wherein the sensing includes sensing a relative distance from a vehicle traveling in front of the motor vehicle, is sensed and a changing from the normal acceleration mode into the rapid acceleration mode is prevented if the relative distance becomes or is less than a desired safety distance.

19. The method as claimed in claim 11, wherein the acceleration mode is changed over from the rapid acceleration mode into the normal acceleration mode when the pedal position is returned in a neutral home position direction.

20. The method as claimed in claim 11, further comprising changing, when the acceleration mode changes, the engine drive torque in accordance with a predefined function of times.
